(19) United States
(12) Patent Application Publication
(10) Pub. No.: US 2026/0196208 A1
(43) Pub. Date: Jul. 9, 2026

(54) COMPUTER-IMPLEMENTED METHOD FOR PROCESSING NUMBER WORDS BASED ON WORD BUFFER

(71) Applicant: ELISA OYJ, Helsinki (FI)

(72) Inventors: Ville RUUTU, Helsinki (FI); Jussi RUUTU, Helsinki (FI)

(73) Assignee: ELISA OYJ, Helsinki (FI)

(21) Appl. No.: 19/133,288

(22) PCT Filed: Nov. 1, 2023
(86) PCT No.: PCT/FI2023/050606

§ 371 Date: May 28, 2025

(30) Foreign Application Priority Data
Nov. 28, 2022 (FI) 20226057

(51) Int. Cl. G10L 15/05; G10L 15/06; G10L 15/26

(52) U.S. Cl. CPC G10L 15/05; G10L 15/06; G10L 15/26

(57) ABSTRACT

According to an embodiment, a computer-implemented method for processing number words based on a word buffer comprises: obtaining a word buffer; filling a number word buffer based on the word buffer by repeatedly performing: obtaining a current mg word from the word buffer, determining whether the current word is a number word, in response to the current word being a number word, determining whether to combine the current word with a subsequent word in the word buffer based at least on a category of the current word and a category of the subsequent word, in response to determining that the current word should be combined with the subsequent word, combining the current word with the subsequent word thus producing a combined word, and adding the combined word to the number word buffer.

### TECHNICAL FIELD

The present disclosure relates to language processing, and more particularly to a computer-implemented method for processing number words based on a word buffer, a computing device, and a computer program product.

### BACKGROUND

As communication channels digitize, the amount of text-form data increases in the form of, for example, email, chat applications, and social networks. Furthermore, speech-to-text technologies enable the conversion of speech data to text data. These factors also increase the need to process data, such as numerical data, that is in text form.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a computer-implemented method for processing number words based on a word buffer, a computing device, and a computer program product. The foregoing and other objectives are achieved by the features of the independent claims. Further implementation forms are apparent from the dependent claims, the description and the figures.

According to a first aspect, a computer-implemented method for processing number words based on a word buffer comprises: obtaining a word buffer; filling a number word buffer based on the word buffer by repeatedly performing: obtaining a current word from the word buffer, determining whether the current word is a number word, in response to the current word being a number word, determining whether to combine the current word with a subsequent word in the word buffer based at least on a category of the current word and a category of the subsequent word, in response to determining that the current word should be combined with the subsequent word, combining the current word with the subsequent word thus producing a combined word, and adding the combined word to the number word buffer; and in response to determining that the current word should not be combined with the subsequent word, adding a content of the number word buffer and the current word to a result buffer. The method can, for example, efficiently combine number words.

In an implementation form of the first aspect, the obtaining the word buffer comprises: obtaining a text input; dividing the text input into individual words; determining for each individual word, whether the individual word is a number word, and in response to the individual word being a number word, disassembling the individual word into components; and storing each non-number word of the individual words and the components of each number word of the individual words in the word buffer. The method can, for example, efficiently generate the word buffer.

In another implementation form of the first aspect, the obtaining the text input comprises: obtaining an audio input comprising speech; and converting the audio input into the text input using a speech-to-text conversion. The method can, for example, efficiently combine number words based on the audio input.

In another implementation form of the first aspect, the method further comprises determining whether to combine the current word with the subsequent word in the word buffer based further at least on a numerical size of the current word and a numerical size of the subsequent word. The method can, for example, efficiently combine number words based on the numerical size of the number words in, for example, situations where other rules for combining do not produce a satisfactory result.

In another implementation form of the first aspect, the category of the current word and/or the category of the subsequent word is selected from a plurality of categories, wherein the plurality of categories comprises at least one of: a category of words corresponding to numerical digits; a category of words that modify a numerical value of a preceding number word; a category of decade words; a category of words corresponding to multiples of ten; and/or a category of non-number words. The method can, for example, efficiently determine whether the words should be combined.

In another implementation form of the first aspect, the category of words that modify the numerical value of the preceding number word comprises: words that sum a constant value to the numerical value of the preceding number word; and/or words that multiply the numerical value of the preceding number word by a multiple of ten. The method can, for example, efficiently determine whether such number words should be combined.

In another implementation form of the first aspect, the method further comprises: in response to determining that the current word should not be combined with the subsequent word, determining whether the number word buffer is empty; in response to the number word buffer not being empty, adding the content of the number word buffer and the current word to the result buffer; and in response to the number word buffer being empty, adding the current word to the result buffer. The method can, for example, efficiently fill the result buffer.

In another implementation form of the first aspect, the method further comprises, in response to the current word not being a number word, adding the current word to the result buffer. The method can, for example, efficiently process non-number words.

In another implementation form of the first aspect, the method further comprises: after adding the content of the number word buffer and the current word to the result buffer or adding the current word to the result buffer, determining whether the current word is a last word in the word buffer; and in response to the current word being the last word in the word buffer, returning the result buffer. The method can, for example, efficiently determine when to stop processing words from the word buffer.

In another implementation form of the first aspect, the method further comprises, in response to the current word not being the last word in the word buffer, obtaining a new current word from the word buffer. The method can, for example, efficiently determine when to continue processing words from the word buffer.

In another implementation form of the first aspect, the method further comprises, after adding the content of the number word buffer and the current word to the result buffer, emptying the number word buffer. The method can, for example, efficiently initialize the number word buffer for subsequent processing.

In another implementation form of the first aspect, the method further comprises utilising the result buffer in an automatic speech recognition system.

According to a second aspect, a computing device comprises at least one processor and at least one memory including computer program code, the at least one memory and the computer program code being configured to, with the at least one processor, cause the computing device to perform the method according to the first aspect.

According to a third aspect, a computer program product comprises program code configured to perform the method according to the first aspect when the computer program product is executed on a computer.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a flow chart representation of a method according to an embodiment;

FIG. 2 illustrates a flow chart representation of a method according to another embodiment;

FIG. 3 illustrates a flow chart representation of a method according to another embodiment;

FIG. 4 illustrates a table representation of rules for combining number words according to an embodiment;

FIG. 5 illustrates a table representation of data according to an embodiment; and

FIG. 6 illustrates a schematic representation of a computing device according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined in the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

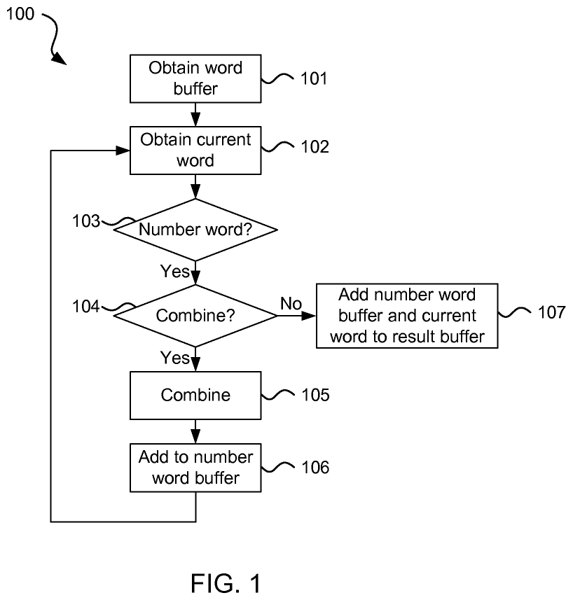

FIG. 1 illustrates a flow chart representation of a method according to an embodiment.

According to an embodiment, a computer-implemented method 100 for processing number words based on a word buffer comprises obtaining 101 a word buffer.

The obtaining 101 the word buffer may comprise, for example, obtaining the word buffer from memory, performing some processing and obtaining the word buffer as a result of the processing, receiving the word buffer from a function/method/device/module, or similar.

The method 100 may further comprise filling a number word buffer based on the word buffer by repeatedly performing: obtaining 102 a current word from the word buffer, determining 103 whether the current word is a number word, in response to the current word being a number word, determining 104 whether to combine the current word with a subsequent word in the word buffer based at least on a category of the current word and a category of the subsequent word, in response to determining that the current word should be combined with the subsequent word, combining 105 the current word with the subsequent word thus producing a combined word, and adding 106 the combined word to the number word buffer.

Herein, the subsequent word may refer to a word that is immediately after the current word in the word buffer.

The method 100 may further comprise, in response to determining that the current word should not be combined with the subsequent word, adding 107 a content of the number word buffer and the current word to a result buffer.

The method 100 may, for example, repeat the operations 102-106 until the current word should not be combined with the subsequent word. Alternatively or additionally, there may be some other conditions, such as those disclosed herein, that may stop the method 100 from repeating the operations 102-106.

The method 100 may further comprise any operations, such as those disclosed in the embodiments herein, before and/or after any of the operations 101-107. Further, at least some of the operations 101-107 may be performed conditionally. For example, the method 100 may further comprise additional conditions that can be checked after any of the operations 101-107 and whether a subsequent operation is performed may depend on the outcome of the condition.

According to an embodiment, the method further comprises utilising the result buffer in an automatic speech recognition system.

The method 100 may, for example, improve the accuracy of processing number words, since the grouping of number words can have a great effect when numerical information is searched from a text. This may be especially significant when automatic speech recognition (ASR) is used, since breaks in the speech of the user can affect how words are grouped. For example, the Finnish word “tuhatsata” may be correspond to the numerical value 1100, while the phrase “tuhat sata” may be interpreted as the two separate numerical values 1000 and 100.

The aforementioned issues may arise, for example, when addresses obtained using ASR are converted to corresponding text data. For example, the address obtained via ASR “harjulan katu seitsemänkymmentä kolme bee lapua” may be converted to “harjulan katu 70 3 bee lapua” when the method 100 is not used, but may be correctly converted to “harjulan katu 73 bee lapua” when the method 100 is used. Similarly, the address “suomenkatu kaksikymmenta yksi liperi” may be converted to “suomenkatu 20 1 liperi” when the method 100 is not used, but may be correctly converted to “suomenkatu 21 liperi” when the method 100 is used. Similarly, the address “partiotie kaksikuusiseitseman juva” may be converted to “partiotie 15 juva” when the method 100 is not used, but may be correctly converted to “partiotie 2 6 7 juva” when the method 100 is used.

At least some embodiments can improve processing of number words and the conversion of number words into numbers.

At least some embodiments can convert number words into numbers in a fashion that is easy to implement with different technical systems and technologies.

Although some embodiments disclosed herein may use words in the Finnish language as examples, any disclosure herein is not limited to processing Finnish words only. Any disclosure herein may apply words, such as number words, in any language, and especially in languages in which the grouping of number words affects the interpretation of the corresponding numerical value.

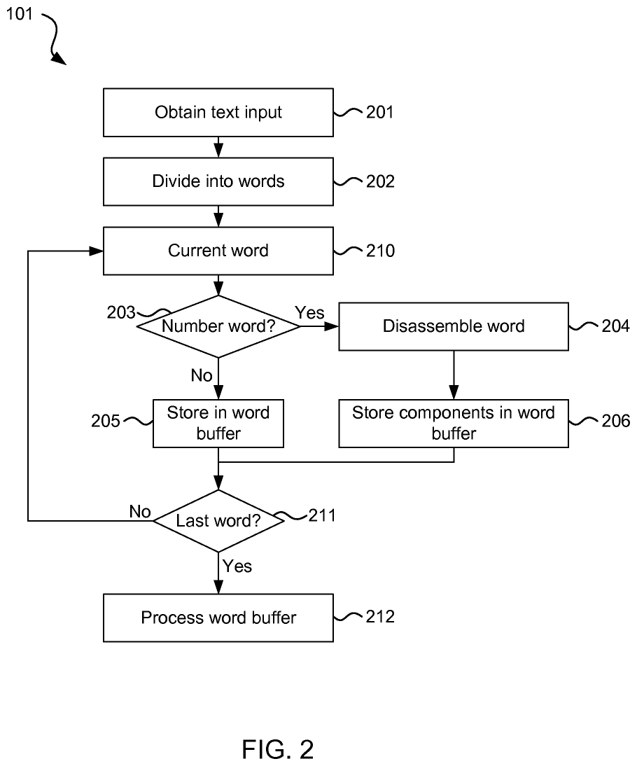

FIG. 2 illustrates a flow chart representation of a method according to another embodiment.

According to an embodiment, the obtaining 101 the word buffer comprises: obtaining 201 a text input; dividing 202 the text input into individual words; determining for each individual word, whether the individual word is a number word, and in response to the individual word being a number word, disassembling the individual word into components; and storing each non-number word of the individual words and storing the components of each number word of the individual words in the word buffer.

According to an embodiment, the obtaining 201 the text input comprises obtaining an audio input comprising speech; and converting the audio input into the text input using a speech-to-text conversion.

The audio input may also be referred to as audio data, audio information, an audio file, or similar. The audio input may comprise, for example, a batch of audio as an audio file or a continuous audio stream.

In the embodiment of FIG. 2, the method 100 may comprise obtaining 210 a current word from the individual words, determining 203, whether the current word is a number word, and in response to the current word being a number word, disassembling 204 the current word into components and storing 206 the components of the current word in the word buffer, and in response to the current word not being a number word, storing 205 the current word in the word buffer. The method 100 may further comprise, determining 211 whether the current word is the last word in the plurality of words. The method 100 may further comprise, in response to the current word not being the last word in the plurality of words, obtaining 210 a new current word from the plurality of words.

Thus, the embodiment of FIG. 2 can obtain the word buffer by repeatedly performing the operations 210, 203, 204, 205, 206, and 211 until the last word in the individual words is reached.

The method 100 may further comprise, in response to the current word being the last word in the plurality of words, processing 212 the word buffer. The processing 212 the word buffer may comprise, for example, operations 102-107 and any other operations, such as those disclosed herein.

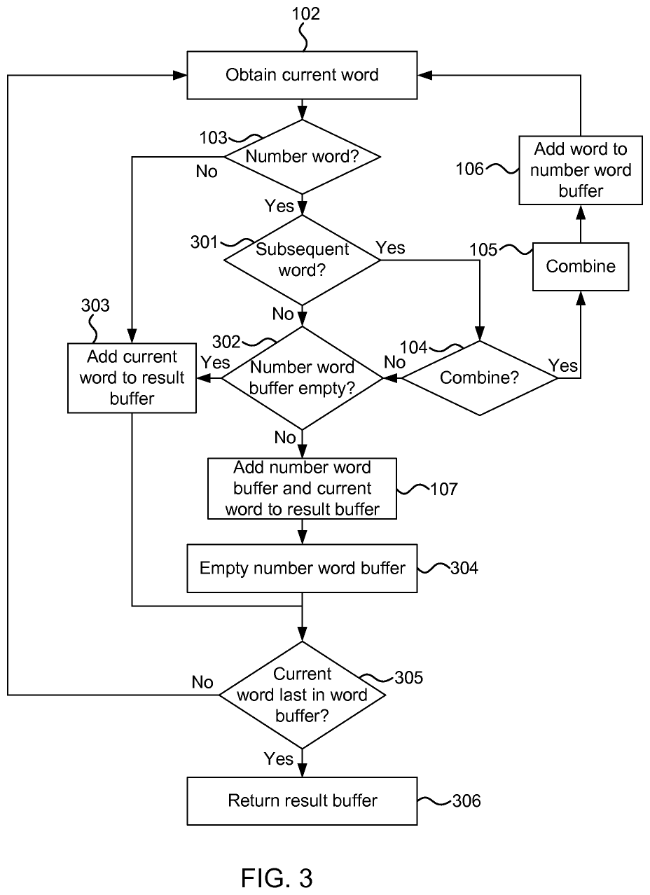

FIG. 3 illustrates a flow chart representation of a method according to another embodiment.

The method 100 may further comprise, in response to determining that the current word is a number word, determining 301 whether there is a subsequent word in the word buffer.

The method 100 may further comprise, in response to determining that there is a subsequent word in the word buffer, determining 104 whether to combine the current word with the subsequent word in the word buffer based at least on a category of the current word and a category of the subsequent word.

According to an embodiment, the category of the current word and/or the category of the subsequent word is selected from a plurality of categories, wherein the plurality of categories comprises at least one of: a category of words corresponding to numerical digits; a category of words that modify a numerical value of a preceding number word; a category of decade words; a category of words corresponding to multiples of ten; and/or a category of non-number words.

The category of words corresponding to numerical digits may comprise words corresponding to numbers 0-9. The category of words corresponding to numerical digits may comprise such words in any language.

According to an embodiment, the category of words that modify the numerical value of the preceding number word comprises: words that sum a constant value to the numerical value of the preceding number word; and/or words that multiply the numerical value of the preceding number word by a multiple of ten.

For example, words that sum a constant value to the numerical value of the preceding number word may comprise the Finnish word “toista”. When “toista” is added to the end of a Finnish word corresponding to numerical digits 1-9, ten is added to the numerical value of the word. For example, “yksi” corresponds to the numerical value 1, while “yksitoista” corresponds to the numerical value 11.

The words that multiply the numerical value of the preceding number word by a multiple of ten may comprise, for example, words such Finnish words “kymmenta”, “sataa”, “tuhatta”, “miljoonaa”, “miljardia”. For example, “kaksi” corresponds to the numerical value 2, while “kaksikymmenta” corresponds to the numerical value 20, “kaksisataa” corresponds to the numerical value 200, and so on. Thus, such words indicate the decade of the preceding number word. For example, “kymmenta” may be considered to correspond to the decade 10¹, “sataa” may be considered to correspond to the decade 10², and so on. The words that multiply the numerical value of the preceding number word by a multiple of ten may also be referred to as multiplier words, multipliers, decade words, decades, or similar.

The category of words corresponding to multiples of ten may comprise, for example, words such as Finnish words “kymmenen”, “sata”, “tuhat”, “miljoona”, “miljardi”, and so on.

The method 100 may further comprise, in response to determining that there is no subsequent word in the word buffer, determining 302 whether the number word buffer is empty. Such a situation may arise, for example, if the current word is the last word in the word buffer.

According to an embodiment, the method 100 further comprises determining whether to combine the current word with the subsequent word in the word buffer based further at least on a numerical size of the current word and a numerical size of the subsequent word.

According to an embodiment, the method 100 further comprises, in response to the current word comprising a word that multiplies the numerical value of the preceding number word by a multiple of ten and the subsequent word comprising a word that multiplies the numerical value of the preceding number word by a multiple of ten, determining whether to combine the current word with the subsequent word in the word buffer based further at least on a numerical size of the current word and a numerical size of the subsequent word.

For example, if the current word is a multiplier and the subsequent word is a multiplier, the words can be combined if the numerical value of the current word is less than the numerical value of the subsequent word. For example, if the current word is “sataa” and the subsequent word is “tuhatta”, the words can be combined but if the current word is “tuhatta” and the subsequent word is “sataa”, the words are not combined.

According to an embodiment, the method 100 further comprises, in response to the current word comprising a word corresponding to a multiple of ten and the subsequent word comprising a word corresponding to a multiple of ten, determining whether to combine the current word with the subsequent word in the word buffer based further at least on a numerical size of the current word and a numerical size of the subsequent word.

For example, if the current word is a multiple of ten and the subsequent word is a multiple of ten, the words can be combined if the numerical value of the current word is greater than the numerical value of the subsequent word. For example, if the current word is “sata” and the subsequent word is “kymmenen”, the words can be combined but if the current word is “kymmenen” and the subsequent word is “sata”, the words are not combined.

According to an embodiment, the method 100 further comprises, in response to the current word comprising a word that multiplies the numerical value of the preceding number word by a multiple of ten and the subsequent word comprising a word corresponding to a multiple of ten, determining whether to combine the current word with the subsequent word in the word buffer based further at least on a numerical size of the current word and a numerical size of the subsequent word.

For example, if the current word is a multiplier and the subsequent word is a multiple of ten, the words can be combined if the numerical value of the current word is greater than the numerical value of the subsequent word. For example, if the current word is “sataa” and the subsequent word is “kymmenen”, the words can be combined but if the current word is “kymmmenta” and the subsequent word is “sata”, the words are not combined.

According to an embodiment, the method 100 further comprises, in response to determining that the current word should not be combined with the subsequent word, determining 302 whether the number word buffer is empty, in response to the number word buffer not being empty, adding 107 the content of the number word buffer and the current word to the result buffer and, in response to the number word buffer being empty, adding 303 the current word to the result buffer.

According to an embodiment, the method 100 further comprises, after adding 107 the content of the number word buffer and the current word to the result buffer, emptying 304 the number word buffer.

According to an embodiment, the method 100 further comprises, in response to the current word not being a number word, adding 303 the current word to the result buffer.

According to an embodiment, the method 100 further comprises: after adding 107 the content of the number word buffer and the current word to the result buffer or adding 303 the current word to the result buffer, determining 305 whether the current word is a last word in the word buffer; and in response to the current word being the last word in the word buffer, returning 306 the result buffer.

The returning 306 the result buffer may comprise, for example, providing the result buffer to, for example, a software function/method/subprogram/subroutine, a module, and/or a device. For example, if the method 100 is implemented as a software function, the function can return the result buffer to the procedure calling the function. Returning the result buffer may also be referred to as providing the result buffer.

According to an embodiment, the method 100 further comprises, in response to the current word not being the last word in the word buffer, obtaining 102 a new current word from the word buffer.

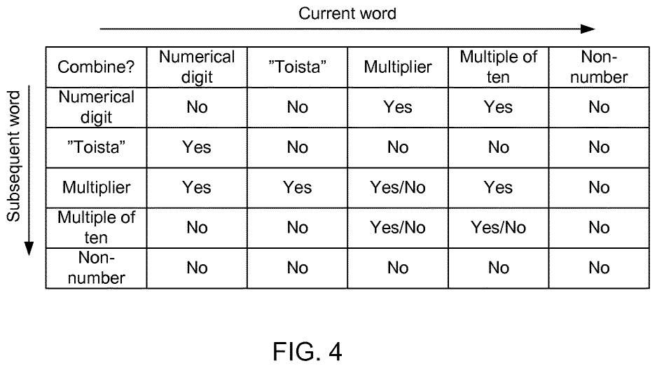

FIG. 4 illustrates a table representation of rules for combining number words according to an embodiment.

Below, exemplary rules for combining the current word and the subsequent word are discussed for the embodiment of FIG. 4.

If the current word comprises a numerical digit and the subsequent word comprises a numerical digit, the words should not be combined. For example, the current word may comprise the word “kolme” and the subsequent word may comprise the word “kaksi”.

If the current word comprises the word “toista” and the subsequent word comprises a numerical digit, the words should not be combined. For example, the current word may comprise the word “toista” and the subsequent word may comprise the word “kolme”.

If the current word comprises a multiplier and the subsequent word comprises a numerical digit, the words should be combined. For example, the current word may comprise the word “sataa” and the subsequent word may comprise the word “kolme”.

If the current word comprises a multiple of ten and the subsequent word comprises a numerical digit, the words should be combined. For example, the current word may comprise the word “sata” and the subsequent word may comprise the word “kolme”.

If the current word or the subsequent word both comprise a non-number word, the words should not be combined.

If the current word comprises a numerical digit and the subsequent word comprises the word “toista”, the words should be combined. For example, the current word may comprise the word “kolme” and the subsequent word may comprise the word “toista”.

If the current word comprises any other word than a numerical digit and the subsequent word comprises the word “toista”, the words should not be combined.

If the current word comprises a numerical digit and the subsequent word comprises a multiplier, the words should be combined. For example, the current word may comprise the word “kolme” and the subsequent word may comprise the word “kymments”.

If the current word comprises the word “toista” and the subsequent word comprises a multiplier, the words should be combined. For example, the current word may comprise the word “toista” and the subsequent word may comprise the word “tuhatta”.

If the current word comprises a multiplier and the subsequent word comprises a multiplier, the words should or should not be combined. Whether the words should be combined can be determined based on the numerical size of the current word and the numerical size of the subsequent word as discussed above. For example, “sataa” and “tuhatta” should be combined while “tuhatta” and “sataa” should not be combined.

If the current word comprises a multiple of ten and the subsequent word comprises a multiplier, the words should be combined. For example, the current word may comprise the word “sata” and the subsequent word may comprise the word “tuhatta”.

If the current word comprises a numerical digit or the word “toista” and the subsequent word comprises a multiple of ten, the words should not be combined. For example, the current word may comprise the word “kolme” and the subsequent word may comprise the word “tuhat” or the current word may comprise the word “toista” and the subsequent word may comprise the word “tuhat”.

If the current word comprises a multiplier and the subsequent word comprises a multiple of ten, the words should or should not be combined. Whether the words should be combined can be determined based on the numerical size of the current word and the numerical size of the subsequent word as discussed above. For example, “sataa” and “kymmenen” should be combined while “kymmenta” and “tuhat” should not be combined.

If the current word comprises a multiple of ten and the subsequent word comprises a multiple of ten, the words should or should not be combined. Whether the words should be combined can be determined based on the numerical size of the current word and the numerical size of the subsequent word as discussed above. For example, “sata” and “kymmenen” should be combined while “kymmenen” and “sata” should not be combined.

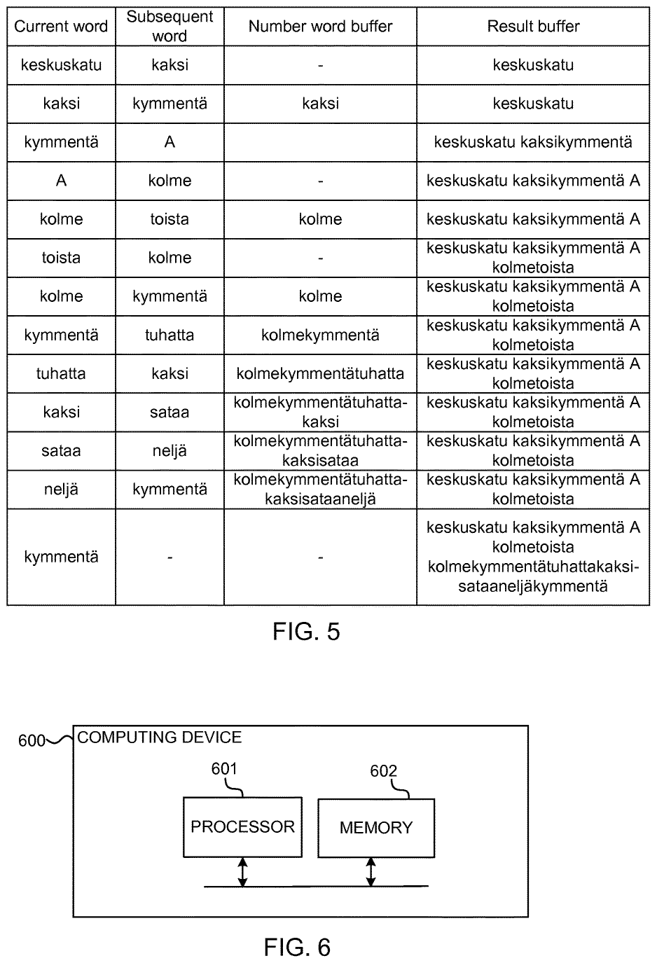

FIG. 5 illustrates a table representation of data according to an embodiment.

The embodiment of FIG. 5 illustrates how the method can process a Finnish address comprising number words and non-number words from the word buffer and store the result in the result buffer. Each row in the table corresponds to obtaining a new current word from the word buffer.

FIG. 6 illustrates a schematic representation of a computing device according to an embodiment.

According to an embodiment, a computing device 600 comprises at least one processor and at least one memory including computer program code, the at least one memory and the computer program code configured to, with the at least one processor, cause the computing device to perform the method 100.

The computing device 600 may comprise at least one processor 601. The at least one processor 601 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The computing device 600 may further comprise a memory 602. The memory 602 may be configured to store, for example, computer programs and the like. The memory 602 may comprise one or more volatile memory devices, one or more non-volatile memory devices, and/or a combination of one or more volatile memory devices and nonvolatile memory devices. For example, the memory 602 may be embodied as magnetic storage devices (such as hard disk drives, magnetic tapes, etc.), optical magnetic storage devices, and semiconductor memories (such as mask ROM, PROM (programmable ROM), EPROM (erasable PROM), flash ROM, RAM (random access memory), etc.).

The computing device 600 may further comprise other components not illustrated in the embodiment of FIG. 6. The computing device 600 may comprise, for example, an input/output bus for connecting the computing device 600 to other devices. Further, a user may control the computing device 600 via the input/output bus.

When the computing device 600 is configured to implement some functionality, some component and/or components of the computing device 600, such as the at least one processor 601 and/or the memory 602, may be configured to implement this functionality. Furthermore, when the at least one processor 601 is configured to implement some functionality, this functionality may be implemented using program code comprised, for example, in the memory.

The computing device 600 may be implemented at least partially using, for example, a computer, some other computing device, or similar.

The method 100 and/or the computing device 600 may be utilised in, for example, automatic speech recognition (ASR) application such as in a so-called voicebot. A voicebot may be configured to obtain information from users by, for example, phone and convert the voice information into text information using ASR. The method 100 may be used to combine number words in the text. The voicebot may further be configured to further process, such as classify, the text information. For example, the voicebot may then convert the combined number words into numerical values more accurately than if the combining was not performed. The voicebot can, for example, ask questions about, for example, basic information from a customer in a customer service situation over the phone, obtain the answers using ASR and the method 100, and save the information in a system. Thus, the customer service situation can be made more efficient and user experience can be improved.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method for processing number words based on a word buffer, the method comprising:
obtaining a text input by obtaining an audio input comprising speech and converting the audio input into the text input using a speech-to-text conversion;
dividing the text input into individual words;
determining for each individual word, whether the individual word is a number word, and in response to the individual word being a number word, disassembling the individual word into components; and
storing each non-number word of the individual words and the components of each number word of the individual words in a word buffer;
filling a number word buffer based on the word buffer by repeatedly performing: obtaining current word from the word buffer, determining whether the current word is a number word, in response to the current word being a number word, determining whether to combine the current word with a subsequent word in the word buffer based at least on a cate-gory of the current word and a category of the subsequent word, in response to determining that the current word should be combined with the subsequent word, combining the current word with the subsequent word thus producing a combined word, and adding the combined word to the number word buffer;
in response to determining that the current word should not be combined with the subsequent word, adding a content of the number word buffer and the current word to a result buffer; and
utilizing the result buffer in an automatic speech recognition system.

2. (canceled)

3. (canceled)

3

4. The computer-implemented method according claim 1, the method further comprising determining whether to combine the cur-rent word with the subsequent word in the word buffer based further at least on a numerical size of the cur-rent word and a numerical size of the subsequent word.

5. The computer-implemented method according to claim 1, wherein the category of the current word and/or the category of the subsequent word is selected from a plurality of categories, wherein the plurality of categories comprises at least one of:
a category of words corresponding to numerical digits;
a category of words that modify a numerical value of a preceding number word;
a category of decade words;
a category of words corresponding to multiples of ten; and/or
a category of non-number words.

6. The computer-implemented method according to claim 5, wherein the category of words that modify the numerical value of the preceding number word comprises:
words that sum a constant value to the numerical value of the preceding number word; and/or
words that multiply the numerical value of the preceding number word by a multiple of ten.

7. The computer-implemented method according to claim 1, the method further comprising:
in response to determining that the current word should not be combined with the subsequent word, determining whether the number word buffer is empty;
in response to the number word buffer not being empty, adding the content of the number word buffer and the current word to the result buffer; and
in response to the number word buffer being empty, adding the current word to the result buffer.

8. The computer-implemented method according to claim 1, the method further comprising, in response to the current word not being a number word, adding the current word to the result buffer.

9. The computer-implemented method according to claim 1, the method further comprising:
after adding the content of the number word buffer and the current word to the result buffer or adding the current word to the result buffer, determining whether the current word is a last word in the word buffer; and
in response to the current word being the last word in the word buffer, returning the result buffer.

10. The computer-implemented method according to claim 9, the method further comprising, in response to the current word not being the last word in the word buffer, obtaining a new current word from the word buffer.

11. The computer-implemented method according to claim 1, the method further comprising, after adding the content of the number word buffer and the current word to the result buffer, emptying the number word buffer.

12. (canceled)

13. A computing device, comprising at least one processor and at least one memory including computer program code, the at least one memory and the computer program code configured to, with the at least one processor, cause the computing device to perform the method according to claim 1.

14. A computer program product comprising program code configured to perform the method according to claim 1 when the computer program product is executed on a computer.
